(19) United States
(12) Patent Application Publication
(10) Pub. No.: US 2024/0190542 A1
(43) Pub. Date: Jun. 13, 2024

(54) FLOATING SOLAR PLANT, AS WELL AS A METHOD FOR MAINTAINING SUCH A SOLAR PLANT

(71) Applicant: CIEL ET TERRE INTERNATIONAL, Sainghin En Melantois (FR)

(72) Inventor: Sylvain CARDON, Faches Thumesnil (FR)

(73) Assignee: CIEL ET TERRE INTERNATIONAL, Sainghin En Melantois (FR)

(21) Appl. No.: 18/529,155

(22) Filed: Dec. 5, 2023

(30) Foreign Application Priority Data
Dec. 9, 2022 (FR) 2213124

(51) Int. Cl. B63B 35/44; H02S 20/00; H02S 40/10; H02S 40/32; H02S 50/00

(52) U.S. Cl. CPC B63B 35/44; H02S 20/00; H02S 40/10; H02S 40/32; H02S 50/00; B63B 2035/4453

(57) ABSTRACT

A floating solar plant, including: floats conferring floatability on the plant, at least one row of photovoltaic panels and a carriage system configured for maintenance of the photovoltaic panels, including: maintenance rails, at least one maintenance carriage including a chassis provided with first rolling/slipping members and with second rolling/slipping members configured respectively to circulate while being guided by the two rails, and wherein the carriage is configured to be moved along the rails, the chassis configured to come astride, above the photovoltaic panels of said at least one row

### FIELD

The present disclosure relates to the field of floating solar plants configured to support photovoltaic panels. Throughout the service life, it might happen that one photovoltaic panel is defective, for example because of the approach of the end of its service life, or the electrical wirings, and possibly the fasteners of the structure require inspection/reparation.

Thus, the maintenance of the plant requires being able to access the members of the plant for inspection, and possibly for maintenance, and for example:
to be able to dismount a used panel to replace it with a properly functioning photovoltaic panel,
to be able to inspect, and where necessary, fasten again, replace the electrical wiring, and possibly tighten again and possibly replace the different fasteners, for example fasteners ensuring the strength of the structure

### BACKGROUND

There is a first type of prior art of floating solar plants which provides for the presence of a maintenance corridor between two rows of photovoltaic panels. The application WO2012/139998A2 is an example of such a plant according to this first type.

This maintenance corridor is arranged parallel to the longitudinal direction of the rows of panels, interposed between the two rows. An operator can then circulate on this maintenance corridor to have access to the different photovoltaic panels of the row, and possibly enable replacement thereof, and still possibly the inspection of the wiring and/or of the fasteners. This maintenance corridor has a width, along a direction transverse to the row typically larger than 40 cm (for example 45 cm), and in order to leave a sufficient gap for the circulation of an operator between the two rows of photovoltaic panels.

A first limitation of this installation type is that it imposes the presence of these physical maintenance corridors, and in particular the presence of floats forming the maintenance corridor, as disclosed by WO2012/139998A2 and which should be dimensioned to ensure taking up the load of an operator.

The second limitation related to this solution with a maintenance corridor is that it imposes a spacing between the two rows of photovoltaic panels to enable the circulation of an operator, which is a surface that is not covered by photovoltaic panels, thereby reducing the electrical energy production yield per surface unit occupied by the plant.

A second type of floating solar plants is also known, for example from the document WO 2021/219948 wherein a spacer structure of the plant ensures a spacing between a first row of photovoltaic panels and a second photovoltaic row. This spacer structure is configured to be immersed so as to enable the circulation of a floating service unit along a waterway between the two rows of panels.

In such a prior art, the maintenance therefore requires the use of a floating service unit configured to circulate along the waterways. Such a prior art allows substantially reducing the size of the floats of the floating solar plant, and therefore the amount of material necessary for making thereof and in comparison with the prior art of the first type.

However, there is still a need for a non-negligible spacing between the rows of photovoltaic panels to enable the creation of a waterway whose width dimension allows ensuring the passage of a hull of the service unit intended to confer floatability of the service unit by taking up the load of the service unit and of the operator.

### SUMMARY

The present invention aims to improve the situation.

A floating solar plant is provided, comprising:
floats conferring floatability on the plant
at least one row of photovoltaic panels extending along a longitudinal direction, fastened to the floats, the photovoltaic panels kept off water by the floats and a carriage system configured for maintenance of the photovoltaic panels, comprising:
maintenance rails comprising at least one first rail and one second rail, extending in parallel, on either side of said at least one row of photovoltaic panels, along the longitudinal direction, spaced apart from one another along a transverse direction
at least one maintenance carriage comprising a chassis provided with first rolling/slipping members and with second rolling/slipping members configured respectively to circulate respectively along a first rail and the second rail while being guided by the two rails, and wherein the carriage is configured to be moved along the rails, the chassis configured to be moved along the rails, the chassis configured to come astride, above the photovoltaic panels of said at least one row.

According to the present disclosure, the maintenance rails are configured to ensure the circulation of said at least one maintenance carriage above the locations of the photovoltaic panels of the row of photovoltaic panels, even though one or more of the photovoltaic panels have been pulled off, and even, according to at least one embodiment, even though all of the photovoltaic panels have been pulled off.

Thus, such a maintenance carriage enables maintenance of the panels, typically by pulling off one or more used panel(s), evacuation thereof by the circulation of the maintenance carriage along the rails and replacement thereof with one or more new panel(s)

The features disclosed in the next paragraphs could, optionally, be implemented. They could be implemented independently of each other or in combination with each other:

According to one embodiment, the maintenance carriage and the maintenance rails are configured to move at least one operator onboard the chassis of the maintenance carriage: in particular the maintenance carriage, as well as the maintenance rails (and in general said plant) may typically be configured to withstand the load of one operator, and possibly two operators onboard the carriage and typically a weight greater than or equal to 100 kg typically for two operators.

According to one embodiment, the maintenance carriage is motor-driven and includes a control module to ensure autonomous or remote-controlled movement thereof, along the maintenance rails.

According to one embodiment, the plant may comprise several rows of panels, extending parallel to one another along the longitudinal direction, the panels of the different rows spaced apart from one another along the transverse direction and comprising a plurality of pairs of rails, spaced apart along the transverse direction, including at least one first pair of rails enabling the circulation of the maintenance carriage astride the photovoltaic panels of a first row and at least one second pair of rails enabling the circulation of the maintenance carriage astride the photovoltaic panels of another row of panels, distinct from the first row in particular a second row.

According to one embodiment, the first row of photovoltaic panels and the second row of photovoltaic panels are spaced apart, along the transverse direction by a clearance δ, enabling the circulation of the first rolling/slipping members or of the second rolling/slipping members, on an intermediate maintenance rail, and wherein the dimension of the clearance δ is smaller than 40 cm, and possibly smaller than 35 cm, and possibly smaller than 25 cm, and for example smaller than 15 cm. Such a small spacing δ allows maximising and densifying the electrical energy production yield per surface unit of the floating solar plant, by minimising surfaces that are not used for capturing the solar radiations, and in comparison with floating solar plants including maintenance corridors between the rows of panels for which this spacing is typically lager than 40 cm to enable the circulation of an operator.

According to one embodiment, the carriage system comprises a transshipment carriage, movable along transshipment rails extending lengthwise along the transverse direction, spaced apart from one another along the longitudinal direction, and wherein the transshipment carriage is configured to support the maintenance carriage and to ensure the transfer of the maintenance carriage from a first position of the transshipment carriage configured to ensure loading of the maintenance carriage from the first pair of rails, and up to a second position of the transshipment carriage configured to ensure unloading of the maintenance carriage on the other pair of rails, in particular the second pair.

In particular, the chassis of the transshipment carriage comprises support rails configured to cooperate with the maintenance carriage, the support rails configured to be aligned respectively with the rails of the first pair of rails in the first position of the transshipment carriage, and to be aligned respectively with the rails of the other pair of rails, in the second position of the transshipment carriage. In general, the transshipment carriage advantageously enables one single maintenance carriage to successively circulates on different rows of panels, by facilitating the operations of transshipment of the maintenance carriage from one pair of rails up to another pair of rails.

According to one embodiment, the maintenance carriage of the panels comprises a gantry structure, shaped as an inverted U, comprising:
a first vertical structure, ensuring support of the first rolling/slipping members,
a second vertical structure ensuring support of the second rolling/slipping members
a transverse structure, extending along the transverse direction, intended to circulate above the panels of said at least one row, the transverse structure linking the first vertical structure and the second vertical structure.

The first rolling/slipping members and the second rolling/slipping members are configured to circulate on the first rail and the second rail arranged entirely or partially at a height under the level of the panels of said at least one row.

According to one embodiment, the maintenance carriage comprises a foldable extension configured to switch from a stowed position, with a smaller footprint over the gantry structure, into a deployed position for which said extension extends in a cantilevered manner from the gantry structure of the carriage to come astride a row of photovoltaic panels, consecutive to said at least one row above which the transverse structure circulates.

According to one possibility, the maintenance carriage is a simple maintenance carriage extending along the transverse direction to come astride one single row of photovoltaic panels. According to another possibility, the maintenance carriage is a multiple maintenance carriage extending along the transverse direction to come astride a plurality of rows of solar panels.

According to one embodiment, the photovoltaic panels of said at least one row are fastened to the maintenance rails, above the maintenance rails, via mechanical interfaces such as fastening brackets, leaving a free gap along the rails for the circulation of the slipping/rolling members, first rolling/slipping members and second rolling/slipping members.

According to one embodiment, the maintenance rails are fastened to the floats.

According to one embodiment, the maintenance carriage is provided with a cleaning system comprising:
spray nozzles, directed so as to project a cleaning fluid over the photovoltaic panels of the row above which the maintenance carriage moves, and/or
brushing means such as a brush, configured so as to brush the photovoltaic panels of the row above which the maintenance carriage moves.

According to one embodiment, the plant comprises an inverter configured to transform the direct current derived from the photovoltaic panels into an alternating current that can be used by the network supported by one or more float(s), and wherein the plant comprises second maintenance rails, directed along the transverse direction, spaced apart along the longitudinal direction on either side of the inverter, as well as a maintenance carriage of the inverter circulating on the second rails configured to lift the inverter and evacuate it.

The present disclosure also relates to a method for maintaining a solar plant according to the present disclosure, comprising moving the maintenance carriage, along the longitudinal direction X, over a row of the photovoltaic panels, suitable for the replacement of a photovoltaic panel, the inspection of the plant, or else cleaning of the photovoltaic panels.

In particular, the maintenance method may typically comprise:
removing at least one used photovoltaic panel from a location of the used panel on said floating solar plant, and evacuating it by lifting the used panel by the maintenance carriage, and moving the maintenance carriage at least along the longitudinal direction X of the maintenance rails, and/or
installing a photovoltaic panel, in particular a new one, by its support by the maintenance carriage, and moving the maintenance carriage along the maintenance rails up to a mounting location on said floating solar plant.

### BRIEF DESCRIPTION OF DRAWINGS

Other features, details and advantages will appear upon reading the detailed description hereinafter, and upon analysing the appended drawings, wherein:

FIG. 1 illustrates, in perspective, an embodiment of a floating solar plant according to the present disclosure comprising floats, and two rows of panels, parallel to one another, extending lengthwise along a lengthwise direction, the two rows being spaced apart along a transverse direction, as well as a carriage system comprising:
a maintenance carriage, configured to move along the longitudinal direction astride, for example over one row of panels, along maintenance rails,
a transshipment carriage movable along transshipment rails, directed along a transverse direction configured to tranship the maintenance carriage from a first pair of maintenance rails, up to a second pair of maintenance rails.

FIG. 1A is a bottom view of FIG. 1, illustrating the positioning of the photovoltaic panels fastened to longitudinal beams of the structure, the beams linking floats together, spaced apart from one another along the longitudinal direction by positioning the photovoltaic panels above the water at the empty spaces promoting cooling of the panels.

FIG. 2 is a detail view which comprises the transshipment carriage, as well as the maintenance carriage, which has been unloaded off the transshipment carriage, the maintenance carriage being, as a non-limiting example, a simple maintenance carriage, configured to circulate astride one single row of photovoltaic panels.

FIG. 3 is a detail view illustrating the simple maintenance carriage, under the chassis of which a photovoltaic panel is suspended, interposed between the first vertical structure and the second vertical structure of the chassis.

FIG. 4 shows to the right a partial sectional view, illustrating the suspension of the panel held by a flexible link, the link being blocked in a cam cleat on the chassis of the carriage, and to the left a detail view of the cam cleat.

FIG. 5 shows a multiple maintenance carriage, meaning that it is configured to come astride several rows of photovoltaic panels, along the transverse direction, in particular astride two rows of panels, the two rows of panels extending in parallel along the longitudinal direction spaced apart from one another along the transverse direction.

FIG. 5a is a view of an alternative of the maintenance carriage, which is illustrated as a multiple one, but which could be simple, provided in particular with a foldable extension, and possibly with two foldable extensions as illustrated, on the sides of the maintenance carriage, said foldable extension configured to switch from a stowed position with a smaller footprint of the carriage (along the transverse direction) into a deployed position for which the extension extends in a cantilevered manner from the gantry of the carriage so as to extend above a consecutive row of photovoltaic panels, FIG. 5a illustrating as example, a left-side first extension, in its deployed position providing access to one row of panels (not illustrated), to the left, and a right-side second extension, in its retracted position, with a smaller footprint, folded on the gantry of the carriage.

FIG. 6 is a view of an inverter configured to transform the direct current derived from the photovoltaic panels into an alternating current that can be used by the network, said inverter supported by one or more float(s), with the presence of the second maintenance rails, directed along the transverse direction, spaced apart along the longitudinal direction on either side of the inverter, for a maintenance carriage of the inverter circulating on the second rails, configured to lift the inverter and evacuate it.

FIG. 7 is an example of a maintenance carriage of the inverter.

FIG. 8 is an advantageous configuration allowing limiting the clearance between two rows of panels, with the presence of an intermediate rail necessary for the movement of the maintenance carriage which is interposed between the two rows, the two rows of panels being inclined according to a simple inclination.

FIG. 9 is an advantageous configuration, allowing limiting the clearance between two rows of panels, with the presence of an intermediate rail necessary for the movement of the maintenance carriage which is interposed between the two rows, the two rows of panels being inclined according to a double inclination, the intermediate rail directly over one top at the intersection of the planes passing through the panels of the two rows.

### DETAILED DESCRIPTION

The drawings and the description hereinafter contain, essentially, elements of a definite nature. Therefore, they may not only serve to gain a better understanding of the present disclosure, but also contribute to the definition thereof, where applicable.

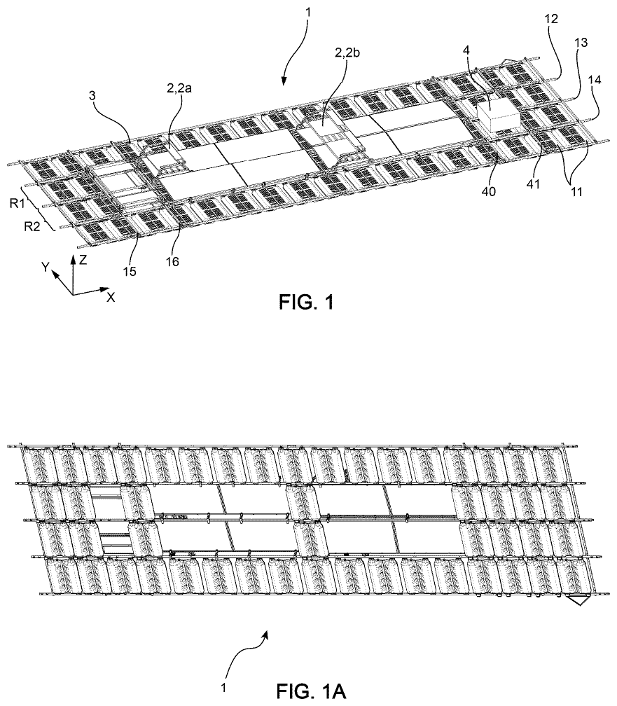

Reference is now made to FIG. 1 which illustrates, for indicative purposes, a floating solar plant according to the present disclosure.

Also, the plant according to the present disclosure comprises:
floats 11 conferring floatability on the plant,
at least one row R1, R2 of photovoltaic panels extending along a longitudinal direction X, fastened to the floats, the photovoltaic panels kept off water by the floats.

In general, the photovoltaic panels have a larger lengthwise dimension and a smaller widthwise dimension.

According to an illustrated possibility, the photovoltaic panels may be directed, according to their lengthwise direction, along the longitudinal direction X, the widthwise direction of the panel being inclined with respect to the horizontal. According to another possibility (not illustrated), the panels may be directed according to their widthwise direction along the longitudinal direction X, the lengthwise direction being inclined with respect to the horizontal.

In general, the longitudinal direction X may be directed according to the East-West direction, and the transverse direction Y may be directed according to the North-South direction. The photovoltaic panels may be inclined with respect to the horizontal. The inclinations of the panels from one row R1, R2 to another may be identical, or different, and possibly the panels may be inclined according to opposite inclinations. In the last case, the direction X may be directed generally according to the North/South direction and the direction Y directed according to the East-West direction.

Nonetheless, preferably, the photovoltaic panels PV belonging to the same row has substantially the same inclination and are coplanar. This may allow facilitating cleaning thereof by circulation of a robot over the row.

A plant typically includes several rows of photovoltaic panels, in particular depending on production capacities. As a non-limiting example, FIG. 1 illustrates an example including only two rows, with a first row R1 of photovoltaic panels and a second row R2 of photovoltaic panels. It should be understood that the number of rows could be greater than 2, for example a number equal to 3, 4, 5, or more.

Such a plant generally extends along its structure in a plane XY, substantially horizontal, and at a height along the vertical direction Z.

These rows of photovoltaic panels R1, R2 extending lengthwise, in parallel according to the longitudinal direction X, and are spaced apart from one another, along the transverse direction Y

The floats 11 may typically consist of plastic components conferring floatability on the plant. For example, the floats may be obtained by blowing extrusion, injection blow moulding, or any other techniques known to a person skilled in the art.

In general, the photovoltaic panels PV may be fastened directly to the floats 11. Still according to one embodiment, illustrated in particular, the photovoltaic panels PV of the rows may be fastened to the floats via beams, which are, in turn, fastened to the floats.

In general, and as illustrated for indication in FIG. 1A, the beams may advantageously enable positioning of the photovoltaic panels fastened to said beams, in particular the longitudinal ones of the structure, the beams linking floats together.

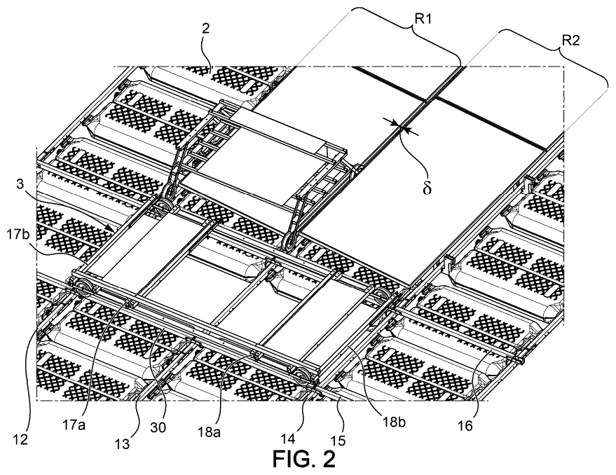

One should notice that the floats 11 could be spaced apart from one another along the longitudinal direction X by positioning the photovoltaic panels PV above the water and in particular at the level of empty spaces promoting cooling of the panels. Such empty spaces beneath the panels are clearly visible in FIG. 2 for which the plant is viewed from the bottom. They enable water to effectively cool down the underside of the panels by convection phenomena between the water surface and the underside of the photovoltaic panels.

At least according to an advantageous embodiment (illustrated), the maintenance ails 12, 13, 14 may advantageously form all or part of the beams ensuring support of the photovoltaic panels PV. Alternatively, the maintenance rails and the support beams may consist of distinct components.

As shown for indication in FIG. 1, in particular, the plant comprises a carriage system configured for the maintenance of the photovoltaic panels PV.

In particular, such a carriage system comprises:
maintenance rails 12, 13, 14 comprising at least one first rail 12 and one second rail 13, extending in parallel, on either side of said row of photovoltaic panels R1, R2, along the longitudinal direction X, the first rail and the second rail spaced apart from one another along a transverse direction Y
at least one maintenance carriage 2 comprising a chassis 20 provided with first rolling/slipping members 21 and with second rolling/slipping members 22. In the figures, the first and second members 21 and 22 are both formed by wheels.

In general, the maintenance rails 12, 13, 14, are typically arranged entirely or partially under the level of the photovoltaic panels. The figures give an embodiment for which all maintenance rails 12, 13, 14 are arranged at a height under the level of the photovoltaic panels, and typically between the photovoltaic panels of the rows. According to another embodiment (not illustrated), one of the rails (first rail 12 or second rail 13) cooperating with the maintenance carriage may be arranged under the level of the photovoltaic panels of rows, while the other rail (respectively second rail 13 or first rail 12) may be arranged art a greater height, for example at the level of the top of the photovoltaic panels.

The first members 21 and the second members 22 are respectively configured to circulate respectively along a first rail 12 and the second rail 13 while being guided by the two rails, the carriage being configured to be moved along the rails, the chassis configured to come astride the photovoltaic panels of said at least one row R1; R2.

Thus, such a maintenance carriage 2 could enable at least one operator to move over the plant along the maintenance rails, by sliding along the rails, and by moving, advantageously astride the row of photovoltaic panels PV. Advantageously, the need for a physical maintenance corridor between the rows of panels is eliminated.

Alternatively or in addition, the maintenance carriage may be motor-driven and in particular include a control module to ensure an autonomous or radio-controlled movement thereof, along the maintenance rails.

According to the present disclosure, the maintenance rails 12, 13, 14 are configured to ensure the circulation of said chassis 20 of said at least one maintenance carriage 2 above the locations of the photovoltaic panels of the row R1; R2 of photovoltaic panels, even though one or more of the photovoltaic panels have been pulled off, and possibly even though all photovoltaic panels have been pulled off, and in particular in order to be able to enable maintenance of the panels, typically pulling off one or more used panel(s), and replacement thereof with one or more new panel(s).

Thus, in the context of the present disclosure, the maintenance rails are distinct components independent of the photovoltaic panels, which extend over a length equal to at least one photovoltaic panel, and possibly typically larger than the length of several panels of the row according to the longitudinal direction X. In particular, and consequently, when the photovoltaic panels comprise cells, typically silicon cells, and a metal frame, typically made of aluminium formed by four metal profiles, bordering the four sides of the cells, the maintenance rails 12, 13, 14, in the context of the present disclosure, are not formed by the profiles of the frame of the photovoltaic panels.

Another advantage of this solution is that it could be implemented, with a small spacing, denoted 8 in FIG. 2, along the transverse direction Y between two consecutive rows R1, R2 of photovoltaic panels, even when a maintenance rail should be arranged for the circulation of the carriage between these two rows R1, R2. Such a small spacing, typically smaller than or equal to 40 cm, for example smaller than or equal to 25 cm contributes to the obtainment of a floating solar plant having a substantially improve electrical yield per surface unit occupied by the plant, in particular in comparison with the aforementioned prior art, of the first type (with a maintenance corridor) or of the second type (with a floating service unit).

The maintenance carriage 2, as well as the maintenance rails 12, 13, (and in general said plant) may typically be configured to withstand the load of an operator, and possibly two operators onboard the carriage, and typically a weight greater than or equal to 100 kg typically for two operators.

In general, the maintenance carriage of the panels 2 may comprise a gantry structure shaped as an inverted U, comprising a first vertical structure S1, ensuring the support of the first rolling/slipping members 21 (for example a pair of wheels), a second vertical structure S2 ensuring support of the second rolling/slipping members 22, (for example a pair of wheels), and a transverse structure 23, extending along the transverse direction Y, intended to circulate above the photovoltaic panels PV of said at least one row R1, R2. The transverse structure 23 links the first vertical structure S1 and the second vertical structure S2, preferably at an upper portion of the vertical structures S1, S2.

The first rolling/slipping members 21 may comprise two rolling/slipping members, spaced apart along the longitudinal direction X and be kept at the bottom portion of the first vertical structure S1.

The second rolling/slipping members 22 may comprise two rolling/slipping members, spaced apart along the longitudinal direction X and be kept at the bottom portion of the second vertical structure S2.

The first rolling/slipping members 21 and the second rolling/slipping members are configured to circulate on the first rail 12 and the second rail 13 entirely or partially arranged under the level of the panels of said at least one row R1; R2, in particular between the rows R1, R2.

In general, the dimension of the first vertical structure S1 or of the second vertical structure S2, along the transverse direction Y is smaller than the spacing δ, and in order to enable the circulation of the vertical structure (first one S1 or second one S2) at the gap between two rows of panels.

According to an advantageous embodiment, the maintenance carriage 2 may comprise a foldable extension EXT configured to switch from a stowed position P2, with a smaller footprint over the gantry structure, up to a deployed position P1 for which said extension EXT extends along the transverse direction Y, in a cantilevered manner from the gantry structure of the carriage to come astride a row of photovoltaic panels, consecutive to said at least one row R1, R2 above which the transverse structure 23 circulates.

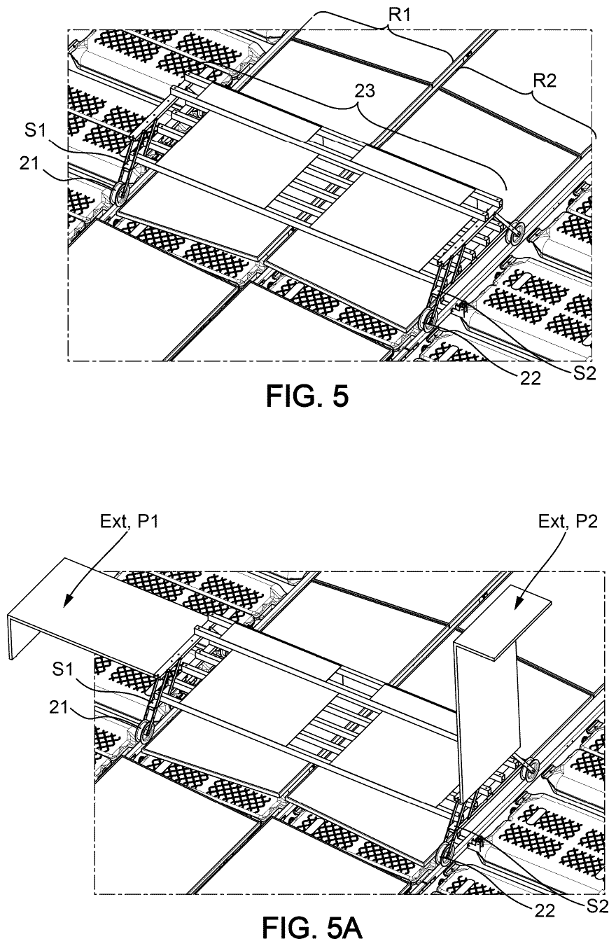

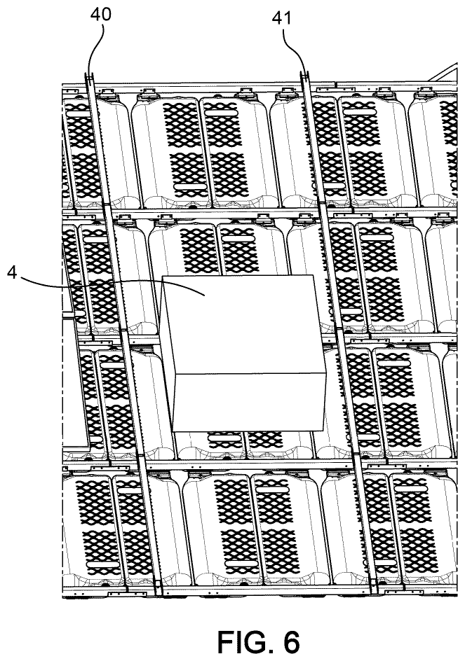

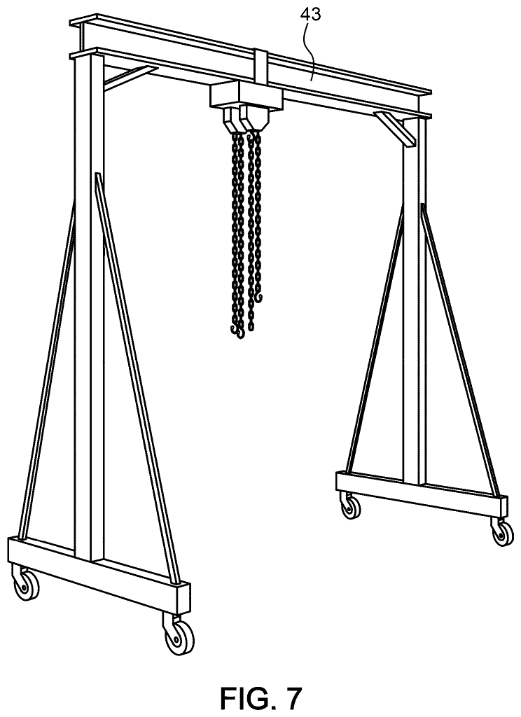

FIG. 5a illustrates a maintenance carriage including two said foldable extensions EXT, on both sides of the gantry structure of the carriage. In general, the foldable extension(s) EXT may be pivotally hinged to the gantry, and extend the transverse structure 23, in the deployed position P1.

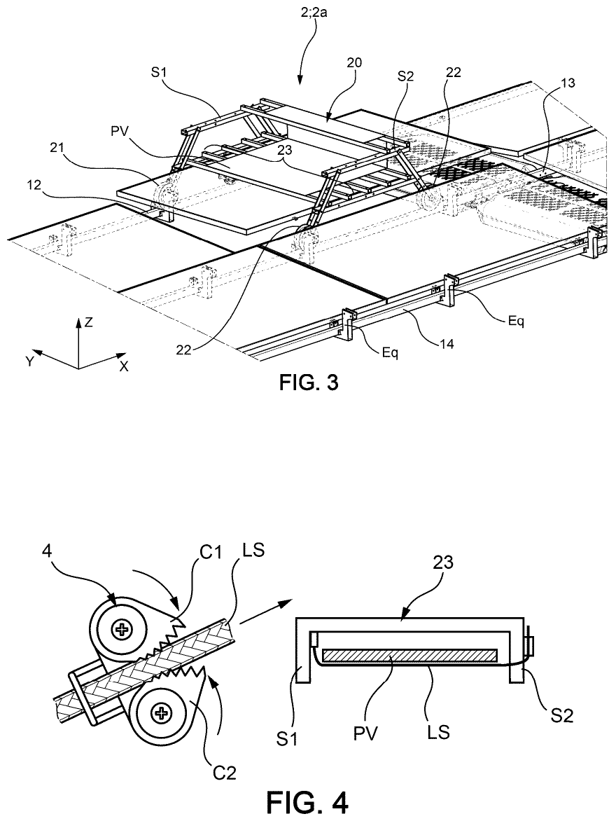

As it could be understood in particular from FIG. 3 or 4, and in general, the maintenance carriage 2 may comprise a suspension system including one or more flexible link(s) LS, configured to suspend a photovoltaic panel under the transverse structure 23 of the structure of the gantry, the photovoltaic panel PV interposed between the first vertical structure S1 and the second vertical structure S2.

Such a suspension system allows safely suspending the panel under the transverse structure 23, and while an operator could be supported above the transverse structure 23.

The suspension system may comprise a cam cleat 4, which comprises two gripping cams C1, C2, elastically biased towards one another between which the flexible link (for example a rope) could be pinched.

The biasing direction of cams allows pulling on the flexible link, so as to enable slipping of the flexible link between the two cams in a first way in order to tension the flexible link. The tension of the flexible link LS ensures keeping the photovoltaic panel sandwiched between the underside of the transverse structure 23 and the tensioned flexible link LS. The biasing way of the cams opposes loosening of the flexible link by slipping of the flexible link in the way opposite to the first way. Such a cam cleat is well known in the nautical industry and its structure is not developed in more detail.

According to one embodiment, the panel maintenance carriage 2 may be a simple maintenance carriage 2a extending along the transverse direction Y so as to come astride one single row of photovoltaic panels R1 or R2. Thus, the dimension of the maintenance carriage 2a along the transverse direction and therefore larger (typically slightly) than the dimension of one row (R1 or R2), along the transverse direction, yet smaller than two rows of panels (R1 and R2), along this transverse direction.

According to one embodiment, the panel maintenance carriage 2 may be multiple maintenance carriage 2b extending along the transverse direction Y so as to come astride a plurality of rows of solar panels R1, R2. FIG. 2 gives an example for which the carriage extends only over two rows of panels R1 and R2. The multiple maintenance carriage may extend over a number of panels greater than 2, such as 3, 4 or 5.

The float solar plant may typically comprise the several rows of panels R1, R2, the rows extending parallel to one another along the longitudinal direction X, the panels of the different rows spaced apart from one another along the transverse direction Y.

The plant may comprise a plurality of pairs of rails 12, 13; 13, 14, spaced apart along the transverse direction, including at least one first pair of rails 12, 13 enabling the circulation of the maintenance carriage 2 astride the photovoltaic panels PV of a first row R1 and at least one second pair of rails 13, 14 enabling the circulation of the maintenance carriage 2 astride the photovoltaic panels of another row of panels, distinct from the first row R1, in particular a second row R2.

Two successive pairs may possibly share a common rail, in this case the rail 13 between the first and second pairs. In particular, the first pair of rails may comprise the first rail 12 and the second rail 13, and the second pair of rails may comprise the second rail 13 and the third rail 14. The second rail is a rail, extending, intermediately between the first row R1 and the second row R2.

According to an advantageous embodiment, the carriage system comprises a transshipment carriage 3, movable along transshipment rails 15, 16 extending lengthwise along the transverse direction Y, spaced apart along the longitudinal direction X.

The transshipment carriage is configured to support the maintenance carriage 2, 2a, 2b and to ensure the transfer of the maintenance carriage 2 from a first position of the transshipment carriage configured to ensure loading of the maintenance carriage from the first pair of rails 12, 13, and up to a second position of the transshipment carriage 3 configured to ensure unloading of the maintenance carriage on the other pair of rails 13, 14, in particular the second pair, or vice versa.

To this end, the chassis 30 of the transshipment carriage may comprise support rails 17a, 18a; 17b, 18b, configured to be aligned respectively with the rails of the first pair of rails 12, 13 in the first position of the transshipment carriage 3 to enable loading/unloading of the maintenance carriage by making the carriage roll from the first pair of rails 12, 13 up to the support rails 17a, 18a: 17b, 18b during loading, or vice versa during unloading, and to be aligned respectively with the rails of the other pair of rails 13, 14, in the second position of the transshipment carriage 3 to enable loading/unloading of the maintenance carriage by making the carriage roll from the second pair of rails 13, 14 up to the support rails 17a, 18a: 17b, 18b, during loading, or vice versa during unloading.

In FIG. 2, the rails 17a, 18a are support rails associated with the axle spacing of the simple maintenance carriage 2a, while the rails 17b, 18b are support rails with the axle spacing of the multiple maintenance carriage 2B.

In general, the transshipment carriage 3 advantageously enables one single maintenance carriage to circulate, successively, over different rows of panels, by facilitating the operations of transshipment of the maintenance carriage 2 from one pair of rails up to another pair of rails. Alternatively, the operator could carry the carriage between the pairs of rails respectively associated with each row, to move the maintenance carriage from one row R1 of panels, to the other row of panels R2. Preferably, the need to provide for several maintenance carriages, associated with the different pairs of rails to ensure maintenance on all of the rows of panels, is avoided.

In general, the maintenance carriage 2 and/or the transshipment carriage 3 may comprise a motor drive, in particular embedded in the carriage. For example, the motor drive may comprise a motor-driven wheel, typically electric, typically belonging to the rolling members, configured to roll on the rails 12, 13, 14. The motor drive may also comprise a drive system, typically with a motor-driven cable.

In general, the first row of photovoltaic panels R1 and the second row of photovoltaic panels R2 are spaced apart, along the transverse direction Y by a spacing δ, enabling the circulation of the first rolling/slipping members 21 or of the second rolling/slipping members on a maintenance rail 13, intermediate between the two rows R1 and R2. Preferably, the dimension δ is smaller than 40 cm, preferably smaller than 35 cm, and possibly smaller than 30 cm, and possibly smaller than 25 cm, and possibly smaller than 15 cm.

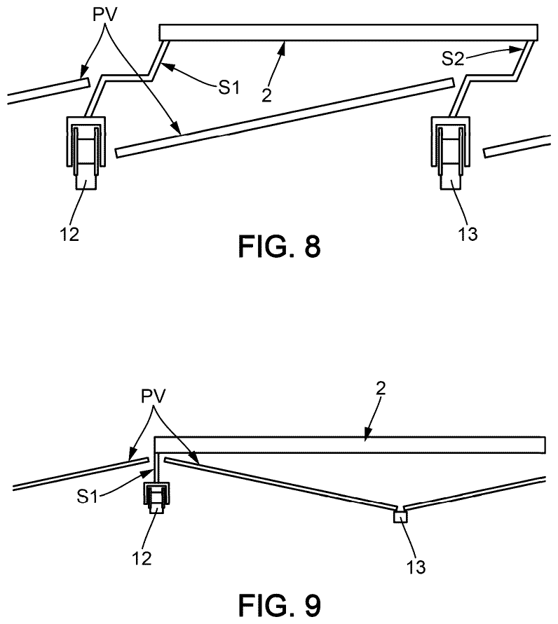

FIG. 8 illustrates an embodiment, when the photovoltaic panels are simply oriented, namely inclined according to the same inclination for both rows R1, R2. As shown in FIG. 8, it is possible to substantially reduce the clearance δ, by acting on the shape of the vertical structures S1, S2. In general, one could notice that the spacing δ could be so small that the rails 12, 13 are covered at least partially, according to the transverse direction Y, by the photovoltaic panels PV of the rows. In particular, it is possible to reduce the clearance δ to the strict minimum for a simple orientation, namely the different photovoltaic panels inclined according to the same inclination are spaced apart by the clearance δ that is strictly necessary to avoid the shading effects between the panels of the two rows R1 R2, which is typically in the range of 250 mm to 300 mm for an inclination from 10° to 15° such as 12° typically from 100 mm to 150 mm for a panel inclination in the range of 3° to 7° such as 5°.

FIG. 9 illustrates an embodiment when the photovoltaic panels of the two rows R1, R2, are inclined according to a dual orientation, namely according to opposite inclinations. The photovoltaic panels PV of the two rows are directed according to two planes, inclined with respect to one another, which intersect along a common edge, at the top of the panels of the two rows R1, R2. The rails 12, 13 are aligned directly over the tops of the panels. The vertical structures of the gantries of the maintenance carriage, cross the rows of panels, at the tops.

According to an advantageous embodiment, the panels of said at least one row R1, R2 are fastened to the maintenance rails 12, 13, 14, above the maintenance rails 12, 13, 14, via mechanical interfaces Eq such as fastening brackets. These mechanical interfaces, U-shaped as illustrated in the figures, leave a free gap along the rails for the circulation of the slipping/rolling members, the first rolling/slipping members 21 and the second rolling/slipping members 22. The maintenance rails 12, 13, 14 are typically fastened to the floats 11, preferably directly.

According to this embodiment, the maintenance rails which extend along the longitudinal direction X combine not only a guide function for the maintenance carriage 2, but also serve as structural support beams for supporting and fastening the photovoltaic panels PV of the row(s) of photovoltaic panels R1, R2.

According to one embodiment, the plant may comprise an inverter 4 configured to transform the direct current derived from the photovoltaic panels into an alternating current that can be used by the network, said inverter 4 being supported by one or more float(s).

Advantageously, the plant may comprise second maintenance rails 40, 41, typically directed along the transverse direction Y, spaced apart along the longitudinal direction X on either side of the inverter 4, as well as a maintenance carriage 43 of the inverter circulating on the second rails 40, 41 configured to come astride the inverter, in order to lift the inverter and evacuate it.

The maintenance carriage may comprise a motor drive ensuring a motor-driven movement along the second rails 40, 41. For example, the motor drive 43 of the carriage may comprise a motor-driven wheel, typically electric, belonging to the rolling members, configured to roll on the second rails 40, 41 1. The motor drive may also comprise a drive system typically with a motor-driven cable.

Alternatively, the inverter may be evacuated by the carriage using the rails 12, 13, 14 extending along the longitudinal direction X between the rows of photovoltaic panels.

The present disclosure also relates to a method for maintaining a solar plant comprising a movement of the carriage along the longitudinal direction X, above one row of the panels, for example for the replacement of a photovoltaic panel, the inspection of the plant, or cleaning of the photovoltaic panels PV.

This movement and the maintenance/inspection/cleaning may be implemented by at least one operator onboard the carriage, or alternatively be entirely or partially automated by the carriage which moves autonomously, namely with no operator onboard.

To this end, the maintenance carriage is motor-driven and includes a control module to ensure movement thereof autonomously, or remote-controlled by an operator, along the maintenance rails.

The present disclosure also relates to a method for maintaining a solar plant according to the present disclosure comprising:
removing at least one used photovoltaic panel PV from a location of the used panel on said floating solar plant, and evacuating it by lifting the used panel by the maintenance carriage 2, moving the maintenance carriage 2 at least along the longitudinal direction X of the maintenance rails 12, 13, 14, and/or
installing a photovoltaic panel P, in particular a new one, by its support by the maintenance carriage 2, and moving the maintenance carriage 2 along the maintenance rails up to a mounting location on said floating solar plant.

### INDUSTRIAL APPLICATION

Advantageously, the plant according to the present disclosure allows eliminating the need for a maintenance corridor for the operator, which form surfaces of the floating solar plant, which are not covered by the photovoltaic panels, namely surfaces that are not used for capturing the solar radiations.

On the contrary, the maintenance carriage 2, circulating astride the panels allows maximising and densifying the electrical energy production yield per surface unit of the floating solar plant, by minimising surfaces that are not used for capturing the solar radiations.

In comparison with a plant according to the prior art of the first type, the plant also has the advantage of being able to reduce the flotation, and therefore the amount of material and volume for the floats, thanks to a better distribution of the load of the operator via the carriage and the rails.

In general, the maintenance carriage may be used to clean the photovoltaic panels of the row of photovoltaic panels.

To this end, the maintenance carriage may be provided with a cleaning system comprising:
spray nozzles, directed so as to project a cleaning fluid over the photovoltaic panels PV of said at least one row R1, R2 of photovoltaic panels above which the maintenance carriage 2 moves, and/or
brushing means such as a brush, configured so as to brush the photovoltaic panels PV of said at least one row R1, R2 above which the maintenance carriage 2 moves.

When the maintenance carriage is motor-driven, electronics such as a programmable controller may be configured to entirely or partially automate the cleaning cycle of the carriage and the motor-driven movement thereof.

### LIST OF REFERENCE SIGNS

1. Floating solar plant,
11. Floats,
12, 13, 14. Maintenance rails,
15, 16. Transshipment rails,
2. Panel maintenance carriage,
2a. Simple maintenance carriage,
2b. Multiple maintenance carriage,
S1, S2. Respectively first vertical structure and second vertical structure,
21, 22. respectively first rolling/slipping members and second rolling/slipping members,
23. Transverse structure,
3. Transshipment carriage,
30. Chassis (Carriage 3),
17a, 18a; 18a, 18b. Support rails (belonging to the transshipment carriage),
LS. Flexible link(s),
X. Longitudinal direction,
Y. Transverse direction
Z. Vertical direction
R1. R2. Respectively first and second rows of photovoltaic panels.
PV. Photovoltaic panels.

1. A floating solar plant, comprising:
floats conferring floatability on the plant,
at least one row of photovoltaic panels extending along a longitudinal direction, fastened to the floats, the photovoltaic panels kept off water by the floats and a carriage system configured for maintenance of the photovoltaic panels, comprising:
maintenance rails comprising at least one first rail and one second rail, extending in parallel, on either side of said at least one row of photovoltaic panels, along the longitudinal direction spaced apart from one another along a transverse direction, and
at least one maintenance carriage comprising a chassis provided with first rolling/slipping members and with second rolling/slipping members configured respectively to circulate respectively along a first rail and the second rail while being guided by the two rails, and wherein the carriage is configured to be moved along the rails, the chassis configured to be moved along the rails, the chassis configured to come astride, above the photovoltaic panels of said at least one row.

2. The floating solar plant according to claim 1, wherein the maintenance carriage and the maintenance rails are configured to move at least one operator onboard the chassis of the maintenance carriage.

3. The floating solar plant according to claim 1, wherein the maintenance carriage is motor-driven and includes a control module to ensure autonomous or remote-controlled movement thereof, along the maintenance rails.

4. The floating solar plant according to claim 1, comprising several rows of panels, extending parallel to one another along the longitudinal direction, the panels of the different rows spaced apart from one another along the transverse direction and comprising a plurality of pairs of rails, spaced apart along the transverse direction, including at least one first pair of rails enabling the circulation of the maintenance carriage astride the photovoltaic panels of a first row and at least one second pair of rails enabling the circulation of the maintenance carriage astride the photovoltaic panels of another row of panels, distinct from the first row in particular a second row.

5. The floating solar plant according to claim 4, wherein the first row of photovoltaic panels and the second row of photovoltaic panels are spaced apart, along the transverse direction by a clearance δ, enabling the circulation of the first rolling/slipping members or of the second rolling/slipping members, on an intermediate maintenance rail, and d wherein the dimension of the clearance δ is smaller than 40 cm.

6. The floating solar plant according to claim 4, wherein the carriage system comprises a transshipment carriage, movable along transshipment rails extending lengthwise along the transverse direction, spaced apart from one another along the longitudinal direction, and wherein the transshipment carriage is configured to support the maintenance carriage and to ensure the transfer of the maintenance carriage from a first position of the transshipment carriage configured to ensure loading of the maintenance carriage from the first pair of rails, and up to a second position of the transshipment carriage configured to ensure unloading of the maintenance carriage on the other pair of rails, in particular the second pair.

7. The floating solar plant according to claim 6, wherein the chassis of the transshipment carriage comprises support rails configured to cooperate with the maintenance carriage, the support rails configured to be aligned respectively with the rails of the first pair of rails in the first position of the transshipment carriage, and to be aligned respectively with the rails of the other pair of rails, in the second position of the transshipment carriage.

8. The floating solar plant according to claim 1, wherein the maintenance carriage of the panels comprises a gantry structure, shaped as an inverted U, comprising a first vertical structure, ensuring support of the first rolling/slipping members, a second vertical structure ensuring support of the second rolling/slipping members, the first rolling/slipping members and the second rolling/slipping members configured to circulate on the first rail and the second rail arranged entirely or partially at a height under the level of the panels of said at least one row, and a transverse structure, extending along the transverse direction, intended to circulate above the panels of said at least one row, the transverse structure linking the first vertical structure and the second vertical structure.

9. The floating solar plant according to claim 8, wherein the maintenance carriage comprises a foldable extension configured to switch from a stowed position, with a smaller footprint over the gantry structure, into a deployed position for which said extension extends in a cantilevered manner from the gantry structure of the carriage to come astride a row of photovoltaic panels, consecutive to said at least one row above which the transverse structure circulates.

10. The floating solar plant according to claim 1, wherein the panel maintenance carriage is a simple maintenance carriage extending along the transverse direction to come astride one single row of photovoltaic panels or the panel maintenance carriage is a multiple maintenance carriage extending along the transverse direction to come astride a plurality of rows of solar panels.

11. The floating solar plant according claim 1, wherein the photovoltaic panels of said at least one row are fastened to the maintenance rails, above the maintenance rails, via mechanical interfaces such as fastening brackets, leaving a free gap along the rails for the circulation of the slipping/rolling members, first rolling/slipping members and second rolling/slipping members.

12. The floating solar plant according claim 1, wherein the maintenance rails are fastened to the floats.

13. The floating solar plant according claim 1, wherein the maintenance carriage is provided with a cleaning system comprising:
spray nozzles, directed so as to project a cleaning fluid over the photovoltaic panels of the row above which the maintenance carriage moves, and/or
brushing means such as a brush, configured so as to brush the photovoltaic panels of the row above which the maintenance carriage moves.

14. The floating solar plant according to claim 1, comprising an inverter configured to transform the direct current derived from the photovoltaic panels into an alternating current that can be used by the network supported by one or more float(s), and wherein the plant comprises second maintenance rails, directed along the transverse direction, spaced apart along the longitudinal direction on either side of the inverter device, as well as a maintenance carriage of the inverter circulating on the second rails configured to lift the inverter and evacuate it.

15. A method for maintaining a solar plant according to claim 1, comprising moving the maintenance carriage, along the longitudinal direction, over a row of the photovoltaic panels, suitable for the replacement of a photovoltaic panel, the inspection of the plant, or else cleaning of the photovoltaic panels.
